(19) United States
(12) Patent Application Publication
(10) Pub. No.: US 2025/0335988 A1
(43) Pub. Date: Oct. 30, 2025

(54) System for Payment Exchange in a Peer to Peer Marketplace

(71) Applicant: Jesse D. Cox, Marco Island, FL (US)

(72) Inventor: Jesse D. Cox, Marco Island, FL (US)

(21) Appl. No.: 18/786,379

(22) Filed: Jul. 26, 2024

Related U.S. Application Data
(60) Provisional application No. 63/639,102, filed on Apr. 26, 2024.

(51) Int. Cl. G06Q 40/04; G06Q 20/02; G06Q 20/36; G06Q 20/38; G06Q 20/42

(52) U.S. Cl. CPC G06Q 40/04; G06Q 20/02; G06Q 20/36; G06Q 20/381; G06Q 20/42

(57) ABSTRACT

A system and marketplace that allows goods and services to be exchanged online for non-tangible assets and crypto-currency wherein the capability of making cross-chain crypto exchanges is provided to users.

### CROSS-REFERENCE TO RELATED APPLICATION

This application claims priority to U.S. provisional patent application No. 63/639,102 filed on Apr. 26, 2024, which is currently pending. The patent application identified above is incorporated herein by reference in its entirety to provide continuity of disclosure.

### FIELD OF THE INVENTION

This invention relates generally to financial transactions, and more specifically, to an online marketplace for third parties to sell tangible products, assets, goods and services in exchange for non-tangible assets and crypto-currency.

### BACKGROUND OF THE INVENTION

Online retail websites and auction sites facilitate the exchange of goods or services for money between third-party sellers and consumers. Conventional platforms allow for the exchange of government currency to consummate each transaction.

However, the buyer typically does not have the option to use these other payment instruments when the seller is an individual as opposed to a retail business that has been pre-established as an online merchant. Although there are multiple benefits of using non-tangible assets and crypto-currencies to purchase goods and services online, no system currently exists to allow for such transactions.

Therefore, a need exists for an online marketplace that allows third parties to sell goods and services in exchange for digital non-tangible assets and crypto-currency.

### SUMMARY OF THE INVENTION

The primary object of the present invention is to provide a system and marketplace that allows goods and services to be exchanged online for non-tangible assets and crypto-currency.

An additional object of the present invention is to provide a method and system wherein the capability of making cross-chain transactions and exchanges of crypto currencies.

The present invention fulfills the above and other objects by providing an online marketplace wherein users are provided with the ability to exchange items or services for digital non-tangible assets and crypto-currency by creating a bridge between Web 2.0 and Web 3.0, which provides individual control of personal data and the use of cryptocurrencies and blockchain.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a schematic diagram showing the present invention;

FIG. 2 is a schematic diagram showing a nontangible currency exchange of the present invention; and

FIG. 3 is a schematic diagram showing an exchange of a tangible asset for a nontangible asset using the system and method of the present invention is illustrated.

### DESCRIPTION OF THE PREFERRED EMBODIMENTS

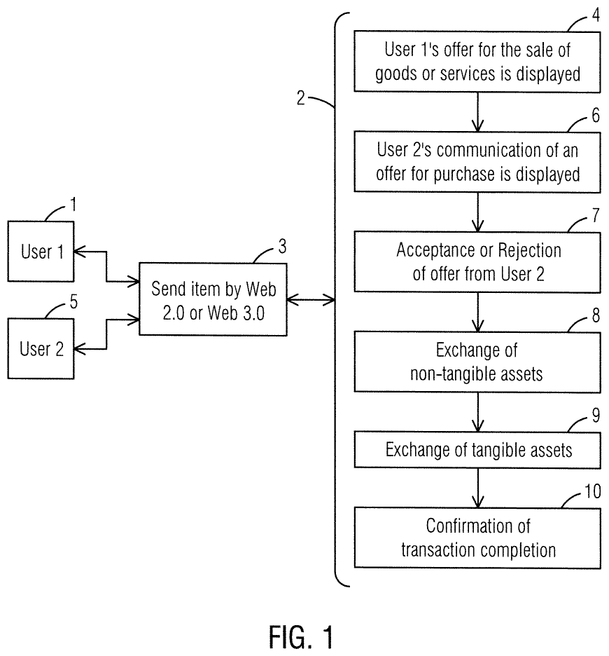

With reference to FIG. 1, a schematic diagram showing a system of the present invention is illustrated. The system and method of the present invention comprises a first user interface 1, such as a computer, tablet, or smartphone, wherein a first user is capable of accessing the online marketplace 2 of the present invention via Web 2.0 or Web 3.0 3 to offer one or more tangible assets for sale 4 in exchange for one or more non-tangible assets, such as crypto-currency. A second user interface 5, wherein a second user is capable of accessing the online marketplace 2 of the present invention to via Web 2.0 or Web 3.0 3 view the first user's offer 6 and to accept or reject the first user's offer 7.

If the first user's offer of sale is accepted, then the nontangible assets may be exchanged 9 for the agreed-to amount of non-tangible assets 8 with a confirmation that the transaction was completed 10. The digital assets may be stored in an online wallet or trust account wherein the system and method of the present invention authenticates the digital assets and transfers the digital assets to a seller's or first party's digital wallet after the transfer of a sold physical asset has been completed.

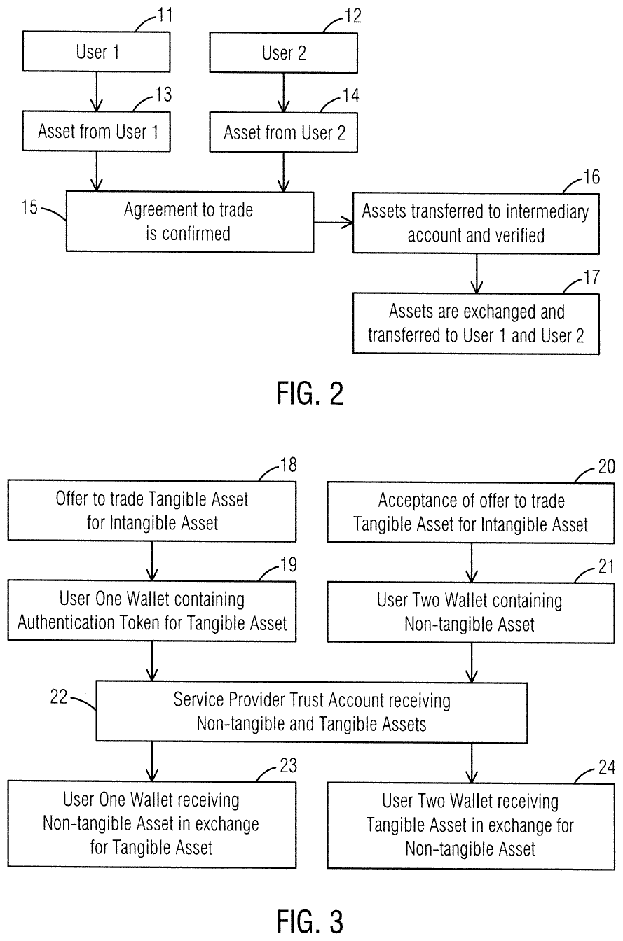

The method and system of the present invention preferably provides capability for cross-chain trading as illustrated in FIG. 2, wherein a first user 11 and a second user 12 agree to exchange a first cryptocurrency 13 for a second cryptocurrency 14. After the agreement is confirmed 15, the assets from each party are transferred to an intermediary account and verified 16. Finally, the nontangible assets are exchanged 17.

This may be accomplished by using a sorting system that transfers assets from the first user to the second user. Digital assets may be verified by connecting online wallets of users wherein a current value of the assets may be determined on an ongoing basis and locked in when a trade is accepted.

With general reference to FIG. 3, a schematic diagram showing an exchange of a tangible asset for a nontangible asset using the system and method of the present invention is illustrated. Initially, a first user provides a description of a tangible asset to be offered for exchange 18. Then, the first user is provided token ID, which is registered on the blockchain 19. Next, a second user accepts the offer to exchange a nontangible asset or cryptocurrency for the tangible asset 20. User one being assigned a digital wallet wherein nontangible assets may be held. Likewise, user two is assigned a digital wallet wherein nontangible assets may be held. Then, the user's nontangible assets are transferred from his or her digital wallet 21 to a trust account controlled by the service provider. Next, possession of the tangible asset is transferred to the service provider/administrator of the platform where the tangible product is authenticated as being non-counterfeit product 22. After authenticating the tangible asset, the nontangible asset is transferred to the first user's wallet 23 and possession and ownership of the tangible asset are transferred to the second user 24, which may be registered on the blockchain.

The system and method may also be used to exchange different crypto-currencies between private parties wherein the values of the exchange is agreed to between a first user and a second user, the nontangible cryptocurrencies are transferred to the service provider's trust account, and then transferred to the receiving parties.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A system comprising:
a first user interface wherein a seller is capable of accessing an online marketplace of the present invention to offer a tangible asset for sale;
a second user interface wherein a purchaser is capable of accessing the online marketplace and making an offer to purchase said tangible asset in exchange for a non-tangible asset;
said tangible asset being exchanged for said non-tangible asset wherein said non-tangible asset is stored in an online trust account capable of authenticating the non-tangible asset;
a confirmation of the tangible asset being transferred to the buyer being generated; and
a transfer of the non-tangible asset to a digital wallet controlled by the seller.

2. The system of claim 1 wherein:
a capability for cross-chain trading wherein a first user and a second user are capable of exchanging a first cryptocurrency for a second cryptocurrency wherein the first cryptocurrency and the second crypto currency are transferred into an intermediary trust account of the present system and authenticated prior to executing a final exchange and transfer between the first user and the second user. the nontangible assets are exchanged and transferred to online wallets controlled by the first user and the second user.
